(19) United States
(12) Patent Application Publication
(10) Pub. No.: US 2019/0052853 A1
(43) Pub. Date: Feb. 14, 2019

(54) DISPLAY CONTROL DEVICE, DISPLAY APPARATUS, TELEVISION RECEIVER, CONTROL METHOD FOR DISPLAY CONTROL DEVICE, AND RECORDING MEDIUM

(71) Applicant: SHARP KABUSHIKI KAISHA, Sakai City, Osaka (JP)

(72) Inventor: YUICHI YOSHIDA, Sakai City (JP)

(21) Appl. No.: 16/079,706

(22) PCT Filed: Feb. 15, 2017
(86) PCT No.: PCT/JP2017/005422

§ 371 Date: Aug. 24, 2018

(30) Foreign Application Priority Data
Mar. 18, 2016 (JP) 2016-056094

(51) Int. Cl. H04N 9/64; H04N 9/77

(52) U.S. Cl. CPC H04N 9/646; H04N 9/77

(57) ABSTRACT

Color noise in a low luminance region of an image is reduced without reducing an information amount of the image. A noise reduction apparatus (1) includes a saturation correction unit (127) configured to reduce saturation of a pixel having luminance lower than luminance corresponding to a first value according to luminance of an image to be displayed on a television set (10) while the luminance of the pixel is maintained.

### TECHNICAL FIELD

The present invention relates to a display control device or the like configured to reduce color noise in an image to be displayed.

### BACKGROUND ART

In recent years, a High Dynamic Range (HDR) signal having an abundant information amount ranging from low luminance to high luminance has been standardized in regard. to a signal of an image (video) to be displayed on a display apparatus such as a television receiver (television set). However, when an image based on the HDR signal is accurately displayed on the display apparatus, color noise may occur in a low luminance region of the image.

### CITATION LIST

### Patent Literature

PTL 1: Japanese Unexamined Patent Application Publication No. 2007-312331 (Publication Date: Nov. 29, 2007)

PTL 2: Japanese Unexamined Patent Application Publication No. 2000-23181 (Publication Date: Jan. 21, 2000)

### SUMMARY OF INVENTION

### Technical Problem

Techniques for reducing noise in an image (video) to be displayed on a display apparatus by using an averaging filter or the like are known. (for example, see PTL 1 and PTL 2 below). However, such techniques involve problems that an information amount of the image decreases, leading to a blurred image and/or loss of x sense of detail.

In view of the foregoing, it is an object of the present invention to realize a display control device or the like configured to reduce color noise in a low luminance region of an image without reducing as information amount of the image.

### Solution to Problem

To achieve the object, a display control device according to one aspect of the present invention includes a saturation changing unit configured to reduce saturation of a pixel having luminance lower than luminance corresponding to a first value according to luminance of an image to be displayed while the luminance of the pixel is maintained.

Moreover, to achieve the object, a control method for a display control device according to an aspect of the present invention includes a saturation changing step of reducing saturation of a pixel having luminance lower than luminance corresponding to a first value according to luminance of an image to be displayed while the luminance of the pixel is maintained.

### Advantageous Effects of Invention

An aspect of the present invention provides the effect that color noise in a low luminance region of an image can be reduced without reducing the information amount of the image.

### BRIEF DESCRIPTION OF DRAWINGS

FIG. 1 is a block diagram illustrating an example of main components of a television set equipped with a noise reduction apparatus according to a first embodiment of the present invention.

FIG. 2 is an outline view illustrating an example of an appearance of the television set shown in FIG. 1.

FIG. 3 is a view illustrating an example of a brightness distribution generated by the noise reduction apparatus shown in FIG. 1.

FIG. 4 is a view illustrating an example of functions which are stored in the noise reduction apparatus shown in FIG. 1 and according to which a luminance coefficient is determined.

FIG. 5 is a planar coordinate system illustrating a relationship of saturation and pigment with respect to blue chrominance and red chrominance.

FIG. 6 is a view illustrating an example of a function which is stored in the noise reduction apparatus shown in FIG. 1 and according to which a saturation coefficient is determined.

FIG. 7 is a view illustrating an example of a function which is stored in the noise reduction apparatus shown in FIG. 1 and according to which a hue coefficient is determined.

FIG. 8 is a flowchart illustrating an example of a flow of a noise reduction process performed by the noise reduction apparatus shown in FIG. 1.

FIG. 9 is a graph illustrating a low luminance range decision coefficient which changes in accordance with a frame luminance maximum value.

FIG. 10 is a block diagram illustrating an example of main components of a television set equipped with a noise reduction apparatus according to a second embodiment of the present invention.

FIG. 11 is a view illustrating a difference of a low luminance range in accordance with a difference in ratio between maximum luminance information and a frame luminance maximum value.

FIG. 12 is a block diagram illustrating an example of main components of a television set equipped with a noise reduction apparatus according to a third embodiment of the present invention.

FIG. 13 is a view illustrating an example of a UI displayed on a display unit of the television set shown in FIG. 12.

FIG. 14 is another example of the UI displayed on the display unit of the television set shown in FIG. 12.

### DESCRIPTION OF EMBODIMENTS

### First Embodiment

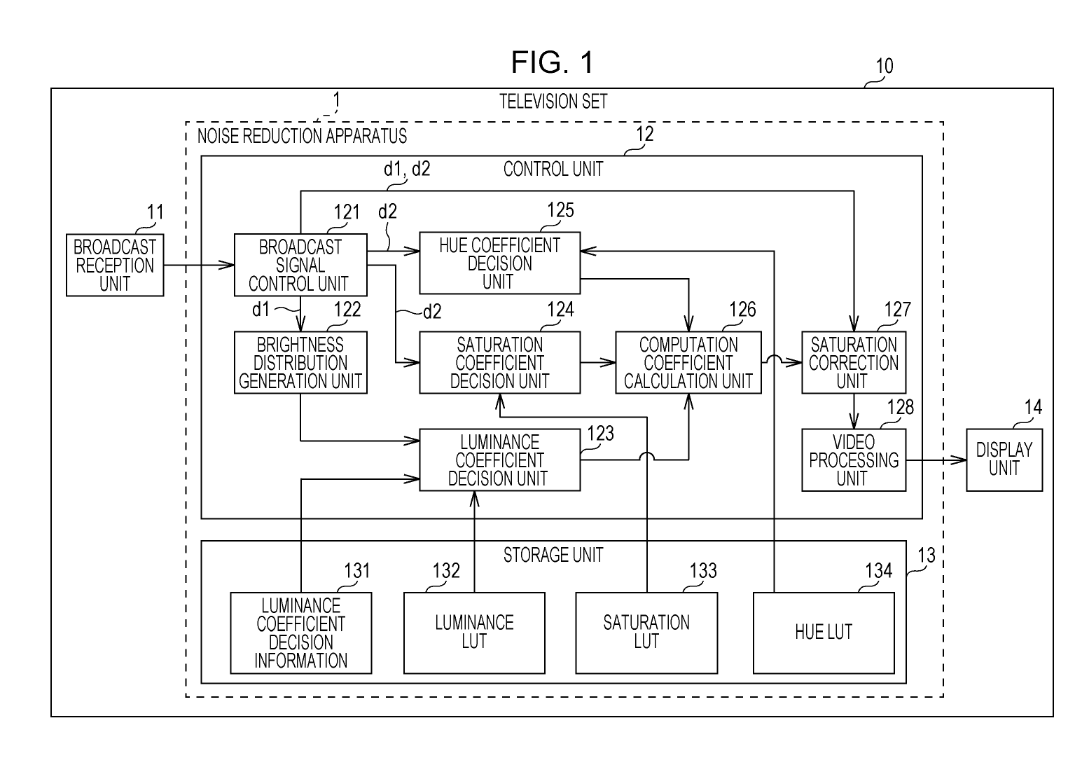

A first embodiment of the present invention will be described in detail below with reference to FIGS. 1 to 9.

### (Scheme of Invention)

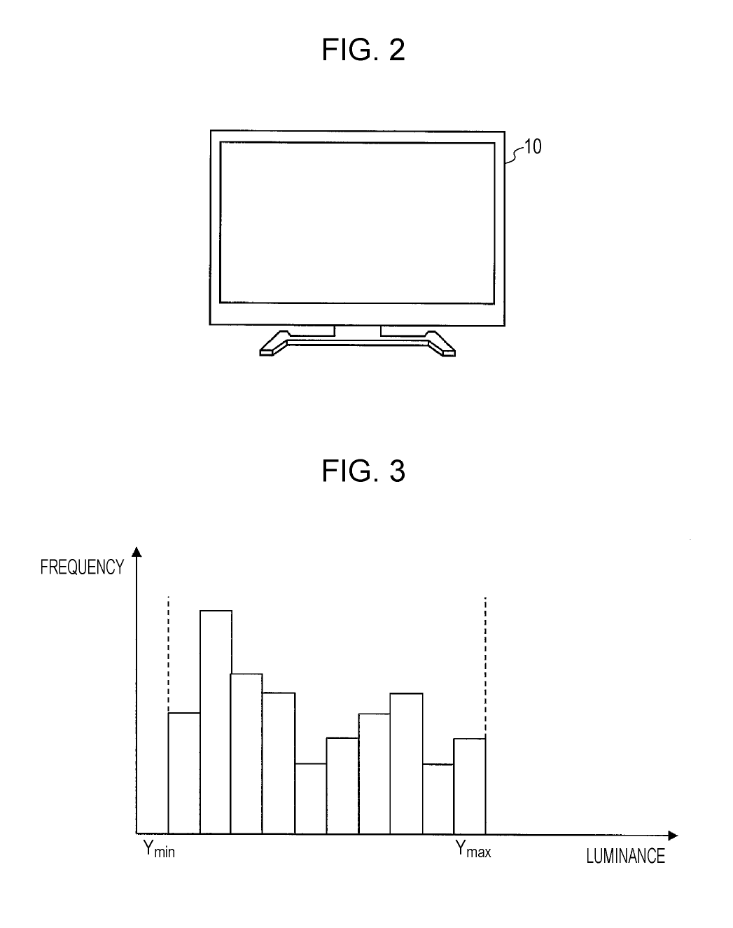

First, a scheme of the present invention will be described with reference to FIGS. 1 and 2. FIG. 1 is a block diagram illustrating an example of main components of a television set 10 equipped with a noise reduction apparatus 1 (display control device) according to the present embodiment. FIG. 2 is an outline view illustrating an example of an appearance of the television set 10 (display apparatus, television receiver).

The noise reduction apparatus 1 shown in FIG. 1 controls displaying of an image by the television set 10. Specifically, the noise reduction apparatus 1 reduces color noise of the image to be displayed by the television set 10. More specifically, the noise reduction apparatus 1 determines a threshold value for determining a pixel in which noise is to be reduced and which is in a still image (hereinafter referred to as a frame) included in a video content (for example, a received broadcast program) to be displayed by the television set 10, the threshold value depending on luminance of the frame. Then, the saturation of a pixel having luminance lower than the threshold value, which is determined, is reduced while maintaining the luminance of the pixel, thereby reducing color noise.

Note that the present embodiment. describes the noise reduction apparatus 1 with which the television set 10 shown in FIG. 2 is equipped. Note that an apparatus which is equipped with the noise reduction apparatus 1 is not limited to the television receiver. For example, a playback device (player) for reproducing recorded video, a display apparatus (monitor) having no tuner, a set-top box, and a tuner for receiving, for example, broadcasts by cable television systems and/or broadcasts via satellite may be equipped with the noise reduction apparatus 1. Note that the playback device may be integrated into a recording device for recording a broadcast program.

### (Main Components of Television Set 10)

Next, main components of the television set 10 equipped with the noise reduction apparatus 1 will be described with reference to FIG. 1. Note that FIG. 1 is a view illustrating among components in the television set 10, only components with high relevance to the present invention. Moreover, components with low relevance to the present invention are not shown, and the illustration and detailed description thereof are omitted.

As illustrated, the television set 10 includes a broadcast reception unit 11 configured to receive a broadcast stream, a control unit 12 configured to control overall components in the television set 10, a storage unit 13 configured to store various types of data to be used in the television set 10, and a display unit 14 configured to display video of a broadcast program. The broadcast reception unit 11 receives, for example, a broadcast stream containing a broadcast program broadcast in digital terrestrial broadcasting, satellite broadcasting, or the like. Moreover, the broadcast reception unit 11 includes, for example, an antenna and a tuner.

The control unit 12 includes a broadcast signal control unit 121, a brightness distribution generation unit 122 (maximum value specification unit), a luminance coefficient decision unit 123, a saturation coefficient decision unit 124, a hue coefficient decision unit 125, a computation coefficient calculation unit 126, a saturation correction unit 127 (saturation changing unit), and a video processing unit 128. Moreover, the storage unit 13 stores luminance coefficient, decision information 131, a luminance look-up table 132, a saturation look-up table 133, and a hue look-up table 134. Note that in FIG. 1, the look-up table is denoted by LUT, and also in the following description, the look-up table is denoted by LUT.

The broadcast signal control unit 121 outputs information of each frame of the broadcast program included in the broadcast stream, which is received, to each component in the control unit 12. Specifically, the broadcast signal control unit 121 outputs luminance information d1 denoting luminance of each pixel of a frame and chrominance information d2 denoting saturation and hue of each pixel of the frame to the saturation correction unit 127. Moreover, the broadcast signal control unit 121 outputs the luminance information d1 to the brightness distribution generation unit 122. Furthermore, the broadcast signal control unit 121 outputs the chrominance information d2 to the saturation coefficient decision unit 124 and the hue coefficient decision unit 125.

Note that when the broadcast signal control unit 121 acquires color component information (specifically, values of a red component, a green component, a blue component of each pixel of the frame), the broadcast signal control unit 121 converts the color component information into the luminance information d1 and the chrominance information d2 and outputs the luminance information d1 and the chrominance information d2 to each component of the above-described control unit 12. Here, as a method for converting the color component information into the luminance information d1 and the chrominance information d2, a known technique may be used.

The brightness distribution generation unit 122 generates a brightness distribution (luminance histogram) of the frame based on the luminance information d1, which is acquired. For example, the brightness distribution generation unit 122 generates the brightness distribution shown in FIG. 3. FIG. 3 is a view illustrating an example of the brightness distribution generated by the brightness distribution generation unit 122. Note that the brightness distribution generated by the brightness distribution generation unit 122 is not limited to the example in FIG. 3. Moreover, the brightness distribution generation unit 122 refers to the brightness distribution, which is generated, to specify a frame luminance maximum value Yₘₐₓ as a maximum value and a frame luminance minimum value Yₘᵢₙ as a minimum value of the luminance of the frame, which is received, and the brightness distribution generation unit 122 outputs the frame luminance maximum value Yₘₐₓ and the frame luminance minimum value Yₘᵢₙ to the luminance coefficient decision unit 123.

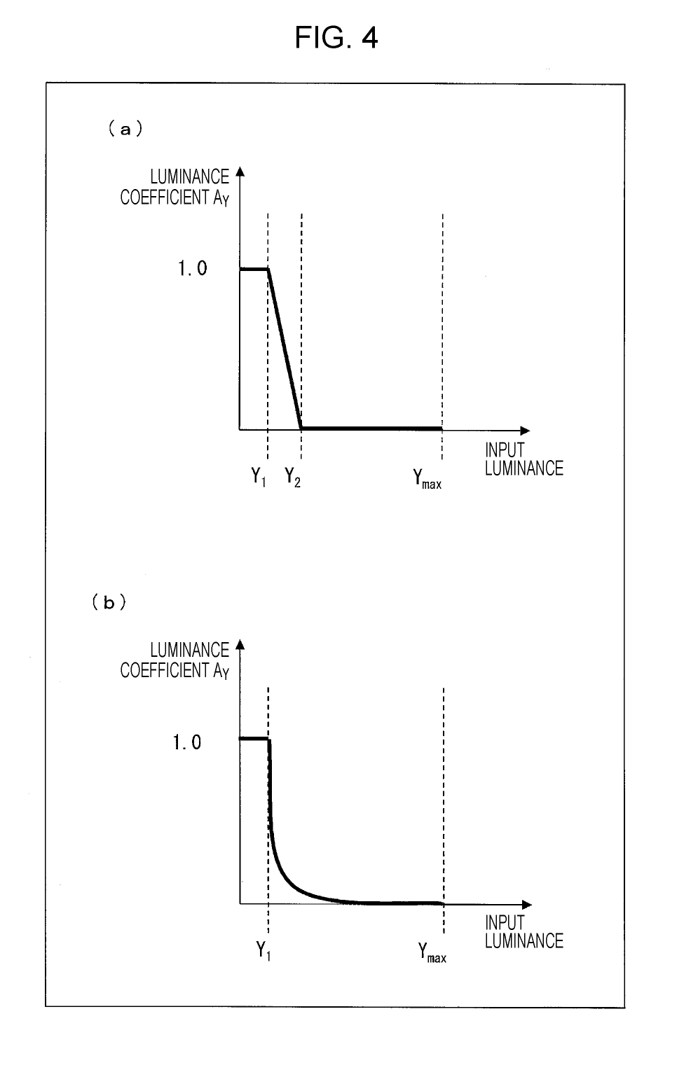

The luminance coefficient decision unit 123 determines a luminance coefficient A_{y} (first coefficient) which is a coefficient according to the luminance of the frame received by the television set 10. Specifically, the luminance coefficient decision unit 123 first reads the luminance LUT 132 from the storage unit 13. The luminance LUT 132 stores information denoting the function of the luminance coefficient A_{Y} with respect to the luminance and, for example, stores the function shown in FIG. 4(a). FIG. 4 is a view illustrating an example of the function stored in the luminance LUT 132.

As illustrated in FIG. 4(a), according to the function stored in the luminance LUT 132, the maximum value of the luminance coefficient A_{Y} is 1.0 within a luminance range of 0 cd/m² to Y₁ cd/m², decreases according to a linear function within a luminance range of Y₁ cd/m² to Y₂ cd/m², and is 0 in the range of from Y₂ cd/m². This is because the noise reduction apparatus 1 according to the present embodiment aims to reduce color noise of a pixel included in a numerical value range regarded as low luminance (that is, numerical value range of 0 cd/m² to Y₂ cd/m², hereinafter referred to as a low luminance range) in a frame whose noise is to be reduced. More specifically, the noise reduction apparatus 1 according to the present embodiment regards the range of 0 cd/m² to Y₁ cd/m² as a noise reduction range and reduces the saturation of the pixel to 0. In other words, the luminance coefficient A_{Y} is a coefficient which decreases as the luminance increases within a range of Y₁ cd/m² to Y₂ cd/m² (prescribed luminance range). Moreover, the noise reduction apparatus 1 regards the range of Y₁ cd/m² to Y₂ cd/m² as an adjustment range, and as the value of the luminance increases, the noise reduction apparatus 1 reduces the luminance coefficient A_{Y} according to a linear function. When the adjustment range is provided, a drastic change of saturation can be suppressed between the pixel whose saturation is reduced to 0 and a pixel whose saturation is not reduced.

Subsequently, the luminance coefficient decision unit 123 determines a value Y₁ and a value Y₂ in the luminance LUT 132 and determines the luminance coefficient A_{Y} at each luminance of the frame. Specifically, the luminance coefficient decision unit 123 reads the luminance coefficient decision information 131 from the storage unit 13, and from the frame luminance maximum value Yₘₐₓ and the luminance coefficient decision information 131, which is read, the luminance coefficient decision unit 123 defines the low luminance range in the frame.

The luminance coefficient decision information 131 includes a low luminance range decision coefficient B, noise reduction range decision information, and adjustment range decision information. The low luminance range decision coefficient B is a coefficient for determining the noise reduction range and. the adjustment range. In other words, the low luminance range decision coefficient B is a coefficient for defining the low luminance range in the frame. In the present embodiment, an example in which the low luminance range decision coefficient B=0.005 is described, but this example should not be construed as limiting. The noise reduction range decision information is information for determining the value Y₁. In the present embodiment, the noise reduction range decision information is a computation formula, and an example in which Y₁=Yₘₐₓ×B is described. However, the noise reduction range decision information is not limited to this example as long as it is information which enables the value Y₁ to be determined. The adjustment range decision information is information for determining the value Y₂. In the present embodiment, the adjustment range decision information is a computation formula, and an example in which Y₂=Y₁×2 is described. However, the adjustment range decision information is not limited to this example as long as it is information which enables the value Y₂ to be determined.

For example, when the frame luminance maximum value Yₘₐₓ is 100 cd/m², the luminance coefficient decision unit 123 determines 0.5 cd/m² for the value Y₁ and 1 cd/m² for the value Y₂. Then, the luminance coefficient decision unit 123 substitutes the value Y₁, the value Y₂, and the frame luminance maximum value Yₘₐₓ into the luminance LUT 132 to determine the luminance coefficient A_{Y} with respect to the luminance of each pixel of the frame, which is received. As illustrated in FIG. 4(a), the luminance coefficient A_{Y} according to the present embodiment is 0 for pixels with luminance higher than or equal to the value Y₂. Here, the value Y₂ of the present embodiment is a value denoting luminance of 1% with respect to the frame luminance maximum value Yₘₐₓ. That is, the luminance coefficient decision unit 123 according to the present embodiment determines that the luminance coefficient A_{Y} of each pixel having luminance higher than or equal to a prescribed percentage with respect to the frame luminance maximum value Yₘₐₓ is 0. Detailed description will be given later, but the noise reduction. apparatus 1 does not reduce the saturation of each pixel whose luminance coefficient A_{Y} is 0. In other words, the noise reduction apparatus 1 reduces the saturation of each pixel having luminance lower than the value Y₂. That is, it can also be said that the luminance coefficient decision unit 123 determines a first threshold value (value Y₂, first value) for determining a pixel in which noise is to be reduced, the first threshold value depending on the luminance of an image.

Moreover, it can also be said that the luminance coefficient decision unit 123 further determines a second threshold value (value Y₁, second value) at the luminance of the image, and for a pixel included in a luminance range of 0 to the value Y₁, the noise reduction apparatus 1 reduces saturation to 0, and for a pixel included in a luminance range of the value Y₁ to the value Y₂, the noise reduction apparatus 1 reduces the extent of reduction of the saturation as the luminance increases.

Finally, the luminance coefficient decision unit 123 outputs to the computation coefficient calculation unit 126 the luminance coefficient A_{Y}, which is determined.

Note that the function. stored in the luminance LUT 132 is not limited to the example in FIG. 4(a). For example, as illustrated in FIG. 4(b), a function which decreases from the value Y₁ to the value Y₂ according to a quadratic function may be stored. That is, in the function stored in the luminance LUT 132, it is only required that the range from the value Y₁ to the value Y₂ corresponds to an attenuation function. Note that when the attenuation function is a function other than a linear function, the noise reduction apparatus 1 is desirably configured to be able to use a computation processor for preparing the attenuation function. Alternatively, the function stored in the luminance LUT 132 may be such a function that the luminance coefficient stepwise decreases as the luminance increases (for example, the luminance coefficient decreases each time the luminance increases by 2).

Moreover, when the frame is overall bright (that is, when the frame luminance minimum value Yₘᵢₙ and the frame luminance maximum value Yₘₐₓ are large), the value Y₁ is also large. Thus, a pixel whose saturation originally does not have to be reduced may also be subjected to a reduction of saturation. Thus, when the frame luminance minimum value Yₘᵢₙ exceeds the prescribed value (for example, 5 cd/m²), the luminance coefficient decision unit 123 may determine the luminance coefficient A_{Y} is 0 regardless of the luminance of pixels of the frame. In this way, when the frame is overall bright, the noise reduction process based on the luminance is not performed, and therefore, it is possible to prevent excessive reduction of saturation.

The saturation coefficient decision unit 124 determines a saturation coefficient A₅ which is a coefficient according to the saturation of the frame received by the television set 10. Specifically, when the saturation coefficient decision unit 124 acquires the chrominance information d2 from the broadcast signal control unit 121, the saturation.

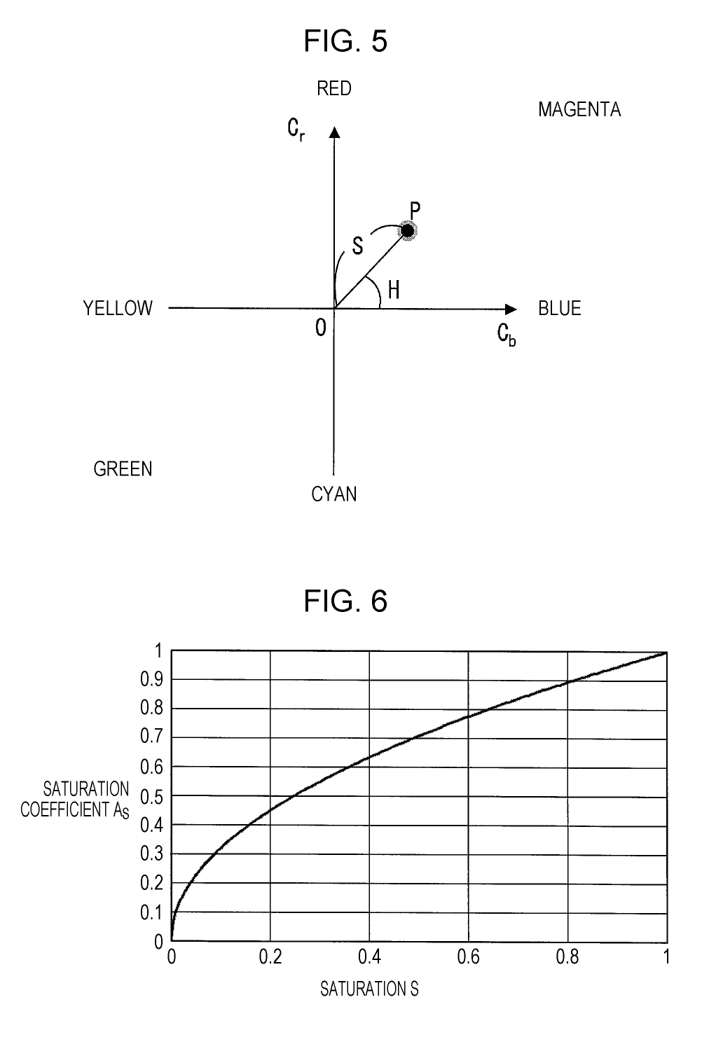

coefficient decision unit 124 first calculates a saturation S of each pixel. Specifically, the chrominance information d2 acquired by the saturation coefficient decision unit 124 includes blue chrominance C_{b} denoting blue saturation and hue and red chrominance Cᵣ denoting red. saturation and hue. Here, with reference to FIG. 5, a relationship of the saturation S and hue H with respect to the blue chrominance C_{b} and red chrominance Cᵣ will be described. FIG. 5 is a planar coordinate system illustrating the relationship of the saturation S and the hue H with respect to the blue chrominance C_{b} and the red chrominance Cᵣ. As illustrated in FIG. 5, when a plane with the blue chrominance C_{b} as the horizontal axis and the red chrominance Cᵣ as the vertical axis is defined, the saturation S of color P (C_{b}, Cᵣ) corresponds to the distance between the origin O and the point P (in other words, the length of a line segment OP), and the hue H corresponds to an angle formed between a straight line passing through the origin O and the point C_{b} on the horizontal axis and a straight line passing through the origin O and the point P. That is, as illustrated in FIG. 5, when H=0, the hue of the pixel is blue, and when H =225, the hue of the pixel is green.

Thus, the saturation coefficient decision unit 124 substitutes the blue chrominance C_{b} and the red chrominance Cᵣ, which are acquired, into the computation formula S=(C_{b}²+Cᵣ²)1/2 to calculate the saturation S. Note that this computation formula is a mere example, and the calculation method of the saturation S is not limited to this example. For example, the blue chrominance C_{b} and the red chrominance Cᵣ, which are acquired, may be substituted into the computation formula S=|Cb|+|Cr| to calculate the saturation S. Note that |Cb| and |Cr| are respectively the absolute value of the blue chrominance C_{b} and the absolute value of the red chrominance Cᵣ. That is, the saturation S increases as the absolute values of the blue chrominance C_{b} and the red chrominance Cᵣ increase, and it is only required that the calculation method of the saturation S is a method that performs computation which can express this relationship.

Subsequently, the saturation coefficient decision unit 124 reads the saturation LUT 133 from the storage unit 13. The saturation LUT 133 stores information denoting the function of the saturation coefficient A_{S} with respect to the saturation S and, for example, stores the function shown in FIG. 6. FIG. 6 is a view illustrating an example of the function stored in the saturation LUT 133. The saturation coefficient decision unit 124 substitutes the saturation S, which is calculated, into the function to determine a saturation coefficient A_{S} with respect to the saturation of each pixel of the frame, which is received. Then, the saturation coefficient decision unit 124 outputs to the computation coefficient calculation unit 126 the saturation coefficient A_{S}, which is determined.

Note that the function stored in the saturation LUT 133 is not limited to the example shown in FIG. 6 as long as it is a function that the value of the saturation coefficient A_{S} increases as the saturation S of the pixel increases.

The hue coefficient decision unit 125 determines a hue coefficient A_{H} which is a coefficient according to the hue of the frame received by the television set 10. Specifically, when the hue coefficient decision unit 125 acquires the chrominance information d2 from the broadcast signal control unit 121, the hue coefficient decision unit 125 first calculates hue H of each pixel. As described above, the hue H corresponds to an angle formed between a straight line passing through the origin O and the point C_{b} on the horizontal axis and a straight line passing through the origin O and the point P in the planar coordinate system in FIG. 5. Thus, the hue coefficient decision unit 125 substitutes the blue chrominance C_{b} and the red chrominance Cᵣ into the computation formula H=tan⁻¹ (Cᵣ/C_{b}) to calculate the hue H. Note that this computation formula is a mere example, and the calculation method of the hue H is not limited to this example.

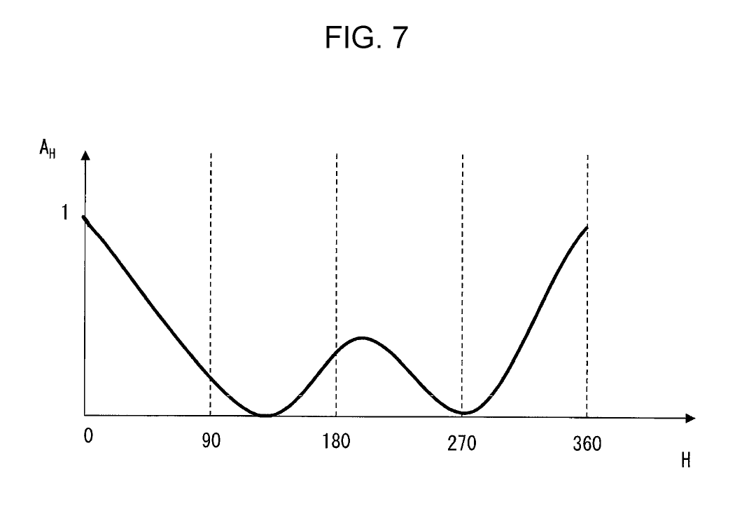

Subsequently, the hue coefficient decision unit 125 reads the hue LUT 134 from he storage unit 13. The hue LUT 134 stores information denoting the function of the hue coefficient A_{H} with respect to the hue H and, for example, stores the function shown in FIG. 7. FIG. 7 is a view illustrating an example of a function stored in the hue LUT 134. The hue coefficient decision unit 125 substitutes the hue H, which is calculated, into the function to determine the hue coefficient A_{H} with respect to the hue of each pixel of the frame, which is received. In other words, it can be said that the hue coefficient A_{H} is coefficient of each pixel according to the hue of each pixel of the frame. Then, the hue coefficient decision unit 125 outputs the hue coefficient A_{H}, which is determined, to the computation coefficient calculation unit 126.

Note that the function stored in the hue LUT 134 is not limited to the example in FIG. 7. In the function shown in FIG. 7, the value of the A_{H} is large at a position where the hue is close to blue (H=0) and yellow (H=0). That is, when the function shown in FIG. 7 is stored in the hue LUT 134, it can be said that the noise reduction apparatus 1 is configured to reduce noise in a pixel whose hue is close to blue and yellow. Note that in pixels whose luminance is included in the low luminance range, color noise is noticeable, in particular, in a pixel whose hue is blue. Thus, the function shown. in FIG. 7 is stored in the hue LUT 134, which enables the noise reduction apparatus 1 to be realized which securely reduces the color noise in a pixel in which. the color noise is noticeable.

The computation coefficient calculation unit 126 calculates a computation coefficient A_{T} (noise reduction coefficient) for reducing the saturation of each pixel of the frame based on the luminance coefficient A_{Y}, the saturation coefficient A_{S}, and the hue coefficient A_{H}. Specifically, the luminance coefficient A_{Y}, the saturation coefficient A_{S}, and the hue coefficient A_{H}, which are acquired, are substituted into the computation formula A_{T}=A_{Y}×A_{A}×A_{H} to calculate the computation coefficient A_{T}. Note that the computation formula for calculating the computation coefficient. A_{T} is a mere example and is not limited to this example. The computation coefficient calculation unit 126 outputs the computation coefficient A_{T}, which is calculated, to the saturation correction unit 127.

Here, the computation coefficient A_{T} according to the present embodiment is a coefficient which is in proportion to the luminance coefficient A. That is, the computation. coefficient A according to the present embodiment is a value which increases as the luminance coefficient A_{Y} increases. Moreover, the computation coefficient A_{T} according to the present embodiment is a coefficient which is in proportion to the saturation coefficient A_{S} determined based on the function (see FIG. 6) stored in the saturation LUT 133 and the hue coefficient A_{H} determined based on the function (see FIG. 7) stored in the hue LUT 134. That is, the computation coefficient A_{T} according to the present embodiment is a larger value for higher saturation, and the computation coefficient A_{T} according to the present embodiment is a larger value for hue closer to blue and yellow.

The saturation correction unit 127 reduces, based on the computation coefficient A_{T}, the saturation of a pixel which is included in pixels of the frame and whose luminance is included within the low luminance range. Specifically, the video processing unit 128 calculates blue chrominance C_{b}′ serving as a blue chrominance C_{b} after correction (in other words, after the saturation is reduced) and red chrominance Cᵣ′ serving as a red chrominance Cᵣ after correction (in other words, after the saturation is reduced) respectively from the blue chrominance C_{b} and the red chrominance Cᵣ included in the chrominance information d2 acquired from the broadcast signal control unit 121 and the computation coefficient A_{T} acquired from the computation coefficient calculation unit 126. More specifically, the blue chrominance C_{b}, the red chrominance Cᵣ and the computation coefficient A_{T}, which are acquired, are substituted into the computation formula C_{b}′=(1−A_{T})×C_{b} and the computation formula Cᵣ′(1−A_{T})×Cᵣ to calculate the blue chrominance C_{b}′ and the red chrominance Cᵣ′. Then, the saturation correction unit 127 outputs the blue chrominance C_{b}′ and red chrominance Cᵣ′, which are calculated, to the video processing unit 128.

Here, correction of the saturation by the saturation correction unit 127 will be described in detail. Detailed description will be given later, but the video processing unit 128 causes the display unit 14 to display a frame based on the luminance information d1, the blue chrominance C_{b}′, and the red chrominance Cᵣ′ acquired from the saturation correction unit 127. As described above, the blue chrominance C_{b}′ and the red chrominance Cᵣ′ are respectively obtained by multiplying the red chrominance blue C_{b} and the red chrominance Cᵣ, which are acquired, by a value obtained by subtracting the computation coefficient A_{T} from 1. Here, as described above, the saturation S is saturation that increases as the absolute value of the blue chrominance C_{b} and the absolute value of the red chrominance Cᵣ increase (for example, the saturation S is saturation calculated based on the computation formula S=(C_{b}²+Cᵣ²)^{1/2}). That is, the saturation S corresponds to a value which changes alone with the value of the blue chrominance and the value of the red chrominance. As stated above, the saturation correction unit 127 changes the value of the blue chrominance C_{b} and the value of the red chrominance Cᵣ to the blue chrominance C_{b}′ and the red chrominance Cᵣ′, thereby changing the saturation of each pixel in the frame displayed on the display unit 14 from the saturation of each pixel of the frame, which is received.

Moreover, as described above, the computation coefficient A_{T} is calculated through multiplication of the luminance coefficient A_{Y}, the saturation coefficient A_{S}, and the hue coefficient A_{H}. That is, the value of the computation coefficient A_{T} increases as the value of each of the luminance coefficient A_{Y}, the saturation coefficient A_{S}, and the hue coefficient A_{H} increases. Here, since each of the luminance coefficient A_{Y}, the saturation coefficient A_{S}, and the hue coefficient A_{H} is a value larger than or equal to 0 and smaller than or equal to 1, the computation coefficient A_{T} is also a value larger than or equal to 0 and smaller than or equal to 1, and in the same way, (1−A_{T}) is also a value larger than or equal to 0 and smaller than or equal to 1. Thus, the value of the blue chrominance C_{b}′ and the value of the red chrominance Cᵣ′ are respectively equal to the value of the blue chrominance C_{b}, which is acquired and the value of the red chrominance Cᵣ, which is acquired (where computation coefficient A_{T}=0), or the absolute value of the blue chrominance C_{b}′ and the absolute value of the red chrominance Cᵣ′ are respectively smaller than the value of the blue chrominance C_{b}, which is acquired and the value of the red chrominance Cᵣ, which is acquired (where 0<computation coefficient. A_{T}≤1). Moreover, the absolute value of the blue chrominance C_{b}′ and the absolute value of the red chrominance Cᵣ′ decrease as the value of the computation coefficient A_{T} increases. That is, the saturation S based on the blue chrominance C_{b}′ and the red chrominance Cᵣ′ (the saturation S of each pixel in the frame displayed on the display unit 14) decrease as the value of the computation coefficient A_{T} increases and the difference from the saturation S of each pixel in the frame, which is received, increases (in other words, as the value of the luminance coefficient A_{Y} increases, the extent of reduction of the saturation S increases).

Moreover, as described above, the value of the luminance coefficient A_{Y} according to the present embodiment is 0 when the luminance of each pixel is not included within the low luminance range (range of 0 cd/m² to Y₂ cd/m²). That is, for each pixel whose luminance is not included within the low luminance range, the computation coefficient A_{T} is 0, and therefore, the noise reduction apparatus 1 does not correct the saturation of the pixel (saturation is not reduced). That is, the noise reduction apparatus 1 according to the present embodiment reduces only the saturation of each pixel having luminance included within the low luminance range.

Moreover, as the luminance information d1, the luminance information d1 of the frame, which is received is output as is to the video processing unit 128. Thus, the frame displayed on the display unit 14 is the frame, which is received, and in which luminance of each pixel is maintained. Note that the broadcast signal control unit 121 may output the luminance information d1 to the video processing unit 128 but not to the saturation correction unit 127.

Moreover, the blue chrominance C_{b}′ and the red chrominance Cᵣ′ are respectively calculated by multiplying the blue chrominance C_{b} and the red chrominance Cᵣ by (1−A_{T}), and therefore, Cᵣ/C_{b}=Cᵣ′/C_{b}′ holds true. Thus, the hue of each pixel of the frame displayed on the display unit 14 is the hue H of each pixel of the frame, which is received, the hue H being maintained.

The video processing unit 128 causes the display unit 14 to display the frame based on the luminance information d1, the blue chrominance C_{b}′, and the red chrominance Cᵣ′, which are acquired. Thus, the display unit 14 displays the frame in which the saturation of a pixel having luminance included within the low luminance range is corrected (saturation is reduced).

As described above, the noise reduction apparatus 1 according to the present embodiment reduces the saturation. of the pixel having low luminance, and therefore, it is possible to reduce the occurrence of color noise in the pixel. Moreover, it is possible to perform a noise reduction process on only a pixel which requires the noise reduction. Moreover, since the luminance of each pixel is maintained, the occurrence of a blurred area or a dark area due to a reduction of the luminance can be reduced.

### (Flow of Noise Reduction Process)

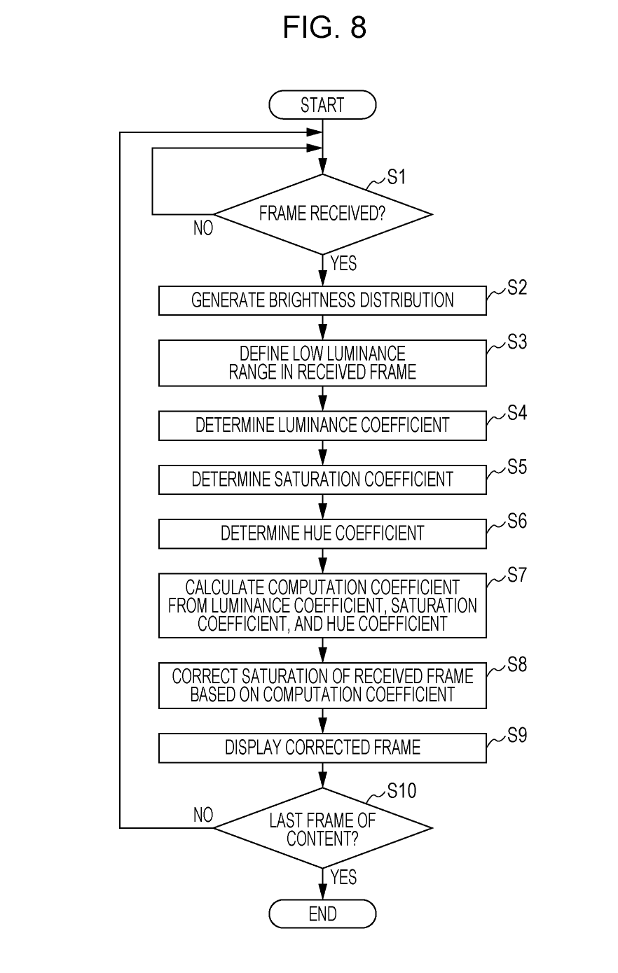

Next, with reference to FIG. 8, a flow of the noise reduction process performed by the noise reduction apparatus 1 will be described. FIG. 8 is a flowchart illustrating an example of the flow of the noise reduction process performed by the noise reduction apparatus 1.

First, the broadcast signal control unit 121 stands by for the reception of a frame of a broadcast program (step S1, hereinafter “step” is omitted). When receiving the frame (if YES is determined in S1), the broadcast signal control unit 121 outputs a luminance information d1 and a chrominance information d2 to the saturation correction unit 127. Moreover, the broadcast signal control unit 121 outputs the luminance information d1 to the brightness distribution generation unit 122. Furthermore, the broadcast signal control unit 121 outputs the chrominance information d2 to the saturation coefficient decision unit 124 and the hue coefficient decision unit 125.

Subsequently, the brightness distribution generation unit 122 generates a brightness distribution based on the luminance information d1, which is acquired (S2). Then, the brightness distribution generation unit 122 refers to the brightness distribution, which is generated, to specify a frame luminance maximum value Yₘₐₓ and a frame luminance minimum value Yₘᵢₙ, and the brightness distribution generation unit 122 outputs the frame luminance maximum value Yₘₐₓ and the frame luminance minimum value Yₘᵢₙ to the luminance coefficient decision unit 123.

Subsequently, the luminance coefficient decision unit 123 defines a low luminance range in the frame, which is received (S3). Specifically, the luminance coefficient decision unit 123 calculates, from the frame luminance maximum value Yₘₐₓ, which is acquired and the low luminance range decision coefficient B read from the storage unit 13, a value Y₁ and a value Y₂ in a function stored in the Luminance LUT 132 read from the storage unit 13 so as to define the low luminance range (in other words, a specific numerical value of the value Y₂). Then, the luminance coefficient decision unit 123 determines a luminance coefficient A_{Y} (S4). Specifically, the value Y₁, value Y₂, and the frame luminance maximum value Yₘₐₓ are substituted into the function stored in the luminance LUT 132, which is read, to determine the luminance coefficient A_{Y} with respect to the luminance of each pixel of the frame, which is received. Note that, as described above, the luminance coefficient A_{Y} for luminance which is not included within the low luminance range is 0. The luminance coefficient decision unit 123 outputs, to the computation coefficient calculation unit 126, the luminance coefficient A_{Y}, which is determined.

Subsequently, the saturation coefficient decision unit 124 determines a saturation coefficient A_{S} (S5). Specifically, the saturation coefficient decision unit 124 calculates the saturation S from a blue chrominance C_{b} and a red chrominance C, included in the chrominance information d2, which is acquired, and the saturation coefficient decision unit 124 substitutes the saturation S, which is calculated, into function stored in the saturation LUT 133 read from the storage unit 13 to determine the saturation coefficient A_{S} with respect to the saturation of each pixel of the frame, which is received. The saturation coefficient decision unit 124 outputs, to the computation coefficient calculation unit 126, the saturation coefficient A_{S}, which is determined.

Subsequently, the hue coefficient decision unit 125 determines a hue coefficient A_{H} (S6). Specifically, the hue coefficient decision unit 125 calculates the hue H from the blue chrominance C_{b} and the red chrominance Cᵣ included in the chrominance information d2, which is acquired, and the hue coefficient decision unit 125 substitutes the hue H, which is calculated, a function stored in the hue LUT 134 read from the storage unit 13 to determine the hue coefficient A_{H} with respect to the hue of each pixel of the frame, which is received. The hue coefficient decision unit 125 outputs, to the computation coefficient calculation unit 126, the hue coefficient A_{E}, which is determined.

Note that it is only required that the processes in S4, S5, and S6 are performed after the process in S3 and before the process in S7, and the order of the processes is not limited to a particular order. Alternatively, the processes in S4, S5, and S6 may be simultaneously performed.

Subsequently, the computation coefficient calculating unit 126 calculates a computation coefficient A_{T} from the luminance coefficient A_{Y}, the saturation coefficient A_{S}, and the hue coefficient A_{H}, which are acquired (S7). Then, the computation coefficient calculation unit 126 outputs, to the saturation correction unit 127, the computation coefficient A_{T}, which is calculated.

Subsequently, the saturation correction unit 127 corrects the saturation of the frame, which is received, based on the computation coefficient, which is acquired (S8, saturation changing step). More specifically, the saturation correction unit 127 substitutes the blue chrominance C_{b}, the red chrominance Cᵣ, and the computation coefficient A_{T}, which are acquired, into the computation formula C_{b}′=(1−A_{T})×Cb and the computation formula Cᵣ′=(1−A_{T})×Cr to calculate the blue chrominance C_{b}′ and the red chrominance Cᵣ′. Then, the saturation correction unit 127 outputs, to the video processing unit 128, the luminance information d1, which is acquired, and the blue chrominance C_{b}′ and red chrominance Cᵣ′, which are calculated.

Finally, the video processing unit 128 causes the display unit 14 to display a corrected frame (S9). Specifically, the video processing unit 128 causes the display unit 14 to display a frame based on the luminance information d1, the blue chrominance C_{b}′, and the red chrominance Cᵣ′, which are acquired. Thus, the display unit 14 displays the frame in which the saturation of a pixel having luminance included within the low luminance range is corrected (saturation is reduced).

### (Variation of First Embodiment)

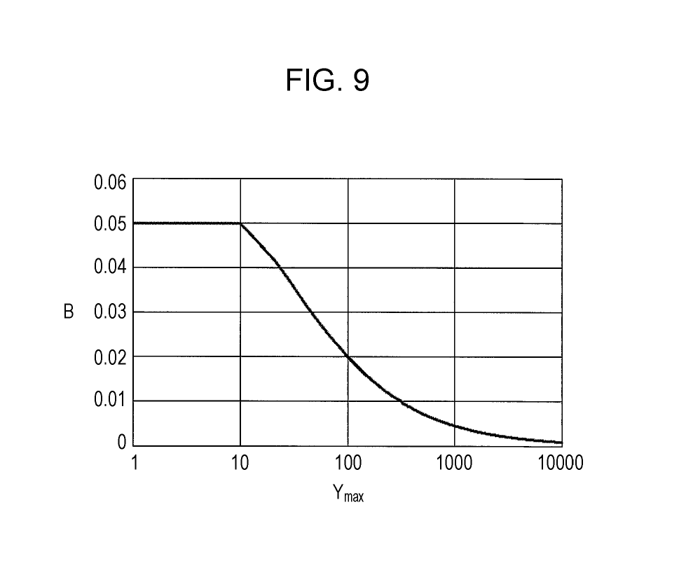

The low luminance range decision coefficient B included in the above-described luminance coefficient decision information 131 is a fixed value regardless of the frame luminance maximum value Yₘₐₓ, but the low luminance range decision coefficient B may be a value according to the frame luminance maximum value Yₘₐₓ. The variation will be described in detail with reference to FIG. 9. FIG. 9 is a graph illustrating a low luminance range decision coefficient B which changes in accordance with the frame luminance maximum value Yₘₐₓ. In a storage unit 13 of a noise reduction apparatus 1 according to the present variation, a LUT storing the function shown in FIG. 9 is stored as luminance coefficient decision information 131. A luminance coefficient decision unit 123 reads the LUT and specifies, from the function shown in the figure, the low luminance range decision coefficient B according to the frame luminance maximum value Yₘₐₓ, which is acquired.

Note that a function for specifying the low luminance range decision coefficient B is not limited to the example shown in the figure. Note that in order to enable the noise reduction process to be performed on only pixels in which the occurrence of color noise is concerned (in other words, pixels whose value of luminance is small) even when the value of the frame luminance maximum value Yₘₐₓ is large, a function as illustrated in the figure is desirable in which the low luminance range decision coefficient B gradually decreases as the frame luminance maximum value Yₘₐₓ increases when the frame luminance maximum value Yₘₐₓ is larger than or equal to the prescribed value.

### Second Embodiment

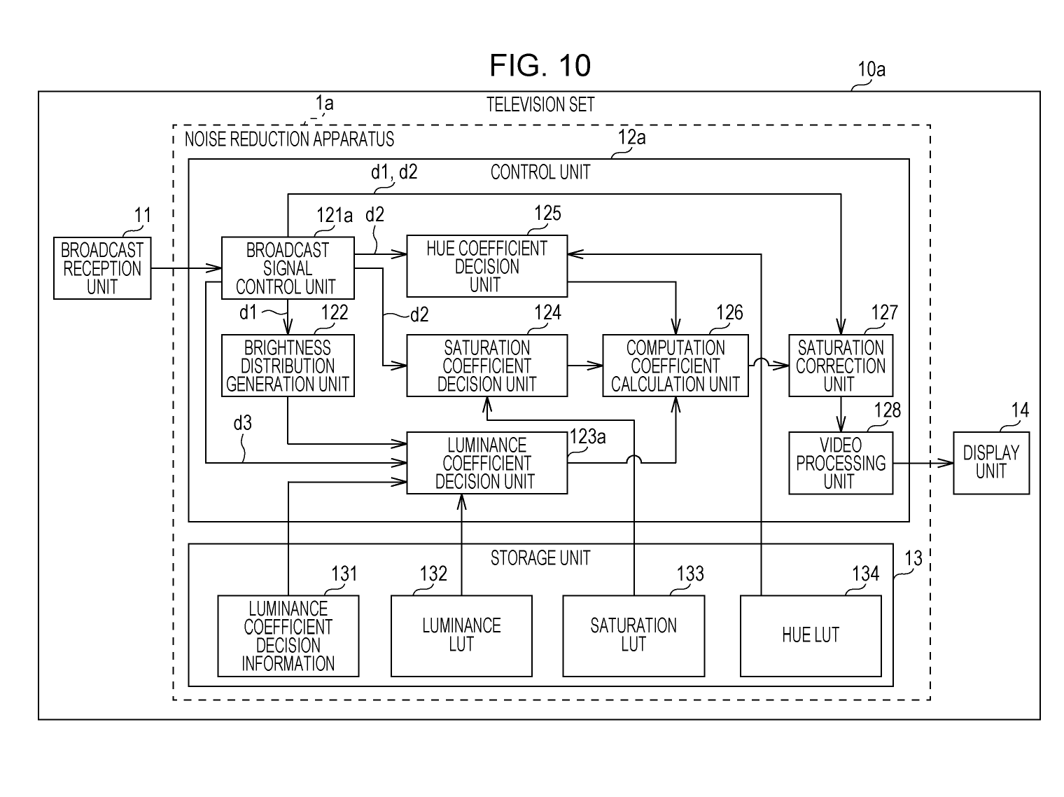

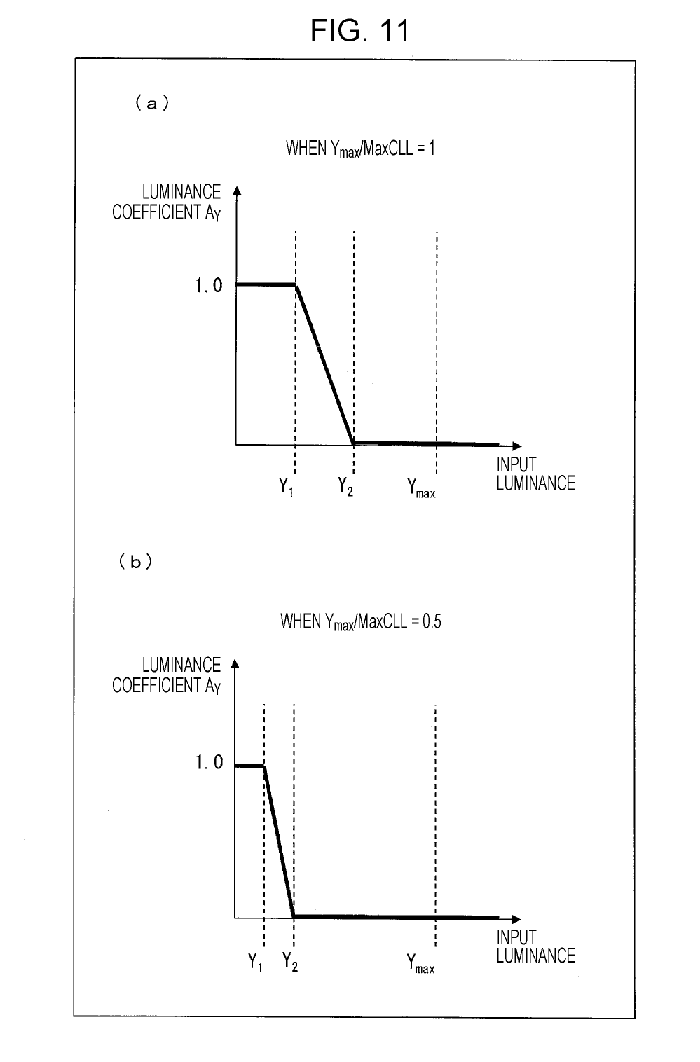

Another embodiment of the present invention will be described below with reference to FIGS. 10 and 11. Note that in the following embodiments, for the sake of description, components having the same functions as those described in the above-described embodiment are denoted by the same reference signs, and the description thereof will be omitted.

FIG. 10 is a block diagram illustrating an example of main components of a television set 10a according to the present embodiment. When a broadcast, stream is a High Dynamic Range (HDR) signal, the television set 10a (in other words, a noise reduction apparatus 1a with which the television set 10a is equipped) defines, based on maximum luminance information (Maximum Content Light Level) included in the broadcast stream and denoting a maximum luminance in a content (a broadcast program) (a maximum value of the luminance of the content), an appropriate low luminance range for each frame of a content. Details of this will be described below.

As illustrated in FIG. 10, the television set 10a includes a control unit 12a instead of the control unit 12. The control unit 12a includes a broadcast signal control unit 121a and a luminance coefficient decision unit 123a respectively instead of the broadcast signal control unit 121 and the luminance coefficient decision unit 123.

The broadcast signal control unit 121a has the function of the above-described broadcast signal control unit 121 and additionally, outputs a maximum luminance information d3 included in the broadcast stream to the luminance coefficient decision unit 123a. Note that the present embodiment describes an example in which the maximum luminance information d3 is information denoting the highest luminance in the content. That is, in the present embodiment, the maximum luminance information d3 corresponds to one value with respect to one content. Moreover, the maximum luminance information d3 is information included in a first frame in the content. Thus, when the broadcast signal control unit 121a acquires the first frame in the content, the broadcast signal control unit 121a outputs the maximum luminance information d3 included in the frame to the luminance coefficient decision unit 123a.

Note that the maximum luminance information d3 does not have to correspond to one value with respect to one content. For example, when the content is divided into several segments, the maximum luminance information d3 may be information denoting the highest luminance in each segment. In this case, the number of pieces of the maximum luminance information d3 existing for one content corresponds to the number of segments. Moreover, in this case, the maximum luminance information d3 is included in the first frame in each segment.

Alternatively, for example, the maximum luminance information d3 may be information denoting the highest luminance in each frame. In this case, the number of pieces of the maximum luminance information d3 existing for one content corresponds to the number of frames. Moreover, in this case, the maximum luminance information d3 is included in each frame. Note that when the maximum luminance information d3 is information denoting the highest luminance in each frame, it is highly possible that the value of the maximum luminance information d3 and a frame luminance maximum value Yₘₐₓ are equal to each other. Note that the maximum luminance information d3 is a value configured on a transmission side of the content whereas the frame luminance maximum value Yₘₐₓ is the highest luminance in a brightness distribution generated by the noise reduction apparatus 1a (i.e., a value specified on a reception side of the content), and therefore, the value of the maximum luminance information d3 and the frame luminance maximum value Yₘₐₓ may be different values. Note that the maximum luminance information d3 may hereinafter be denoted as a maximum luminance value MaxCLL.

The luminance coefficient decision unit 123a is different from the luminance coefficient decision unit 123 in the following points. That is, the luminance coefficient decision unit 123a corrects a low luminance range decision coefficient B read from a storage unit 13 based on the maximum luminance information d3 and the frame luminance maximum value Yₘₐₓ which are acquired (calculates a low luminance range decision coefficient B′ after correction). Specifically, the luminance coefficient decision unit 123a substitutes the maximum luminance value MaxCLL, which is acquired, the frame luminance maximum value Yₘₐₓ, and the low luminance range decision coefficient B read from the storage unit 13 into the computation formula B′=Yₘₐₓ/MaxCLL×B to calculate the low luminance range decision coefficient B′ after correction.

Then, based on the low luminance range decision coefficient B′, which is calculated, a value Y₁ and a value Y₂ are calculated. Note that a specific method for calculating the value Y₁ and the value Y₂ has been described in the first embodiment, and thus the description thereof is omitted here.

As described above, correcting the low luminance range decision coefficient B in accordance with the maximum luminance information d3 and the frame luminance maximum value Yₘₐₓ enables the definition of the low luminance range in a frame of a relatively dark scene in the content to be changed. This will be described with reference to FIG. 11. FIG. 11 is a view illustrating a difference of the low luminance range according to a difference of the ratio of the maximum luminance information d3 (that is, the maximum luminance value MaxCLL) and the frame luminance maximum value Yₘₐₓ (that is, Yₘₐₓ/MaxCLL).

FIG. 11(a) shows a luminance coefficient A_{Y} with respect to the luminance, where Yₘₐₓ/MaxCLL=1, that is, where the frame luminance maximum value Yₘₐₓ in the frame is equal to the maximum luminance in the content. In this example, when the low luminance range decision coefficient B=0.005, and the low luminance range decision coefficient B′ is also 0.005. Therefore, when it is assumed that the computation formula of the value Y₂ is the same as that in the first embodiment, the low luminance range corresponds to a luminance range of 0% to 1% with respect, to the frame luminance maximum value Yₘₐₓ.

In contrast, if, when the frame luminance maximum value Yₘₐₓ is smaller than the maximum luminance in the content, the low luminance range is set to a luminance range of 0% to 1% with respect to the frame luminance maximum value Yₘₐₓ, noise reduction may be performed on a pixel which does not need the noise reduction. Thus, the noise reduction apparatus 1a according to the present embodiment further narrows the low luminance range when the frame luminance maximum value Yₘₐₓ is smaller than the maximum luminance in the content. Thus, it is possible to perform noise reduction on only a pixel which requires the noise reduction. A specific example will he described in FIG. 11(b). FIG. 11(b) shows the luminance coefficient A_{Y} with respect to the luminance, where Yₘₐₓ/MaxCLL=0.5, that is, where the frame luminance maximum value Yₘₐₓ in the frame corresponds to a half of the maximum luminance in the content. In this example, the low luminance range decision coefficient B′=0.5×0.005=0.0025, and therefore, the low luminance range is set to a luminance range of 0% to 0.5% with respect to the frame luminance maximum value Yₘₐₓ. Note that it can also be said that the low luminance range decision coefficient B′ (prescribed ratio) according to the present embodiment is small when the difference between the frame luminance maximum value Yₘₐₓ and the maximum luminance value MaxCLL is large, and the low luminance range decision coefficient B′ is large when the difference between the frame luminance maximum value Yₘₐₓ and the maximum luminance value MaxCLL is small.

As described above, the noise reduction apparatus 1a according to the present embodiment corrects the low luminance range decision coefficient B in accordance with the ratio (Yₘₐₓ/MaxCLL) of the maximum luminance value MaxCLL and the frame luminance maximum value Yₘₐₓ. This defines an appropriate low luminance range for each frame, and thus, it is possible to perform the noise reduction on only a pixel which requires the noise reduction.

### (Variation of Second Embodiment)

The above-described luminance coefficient decision unit 123a uses the maximum luminance value MaxCLL to correct the low luminance range decision coefficient B. However, a method for using the maximum luminance value MaxCLL is not limited to this example. For example, the luminance coefficient decision unit 123a. may use the maximum luminance value MaxCLL instead of the frame luminance maximum value Yₘₐₓ to calculate the value Y₁ and the value Y₂. In this example, the computation formula for calculating the value Y₁ is Y₁=MaxCLL×B.

Moreover, the noise reduction apparatus 1a may define a suitable low luminance range for each frame of a content based on average luminance information (Maximum Frame Average Light Level, hereinafter, the average luminance information may be referred to as an average luminance value MaxFALL) instead of the maximum luminance information d1, the average luminance information being included in the broadcast stream and denoting the average luminance in the content (average value of luminance of content). Note that a specific process performed by the luminance coefficient decision unit 123a of this case is similar to the above-described process except that the maximum luminance value MaxCLL in the above-described process is replaced with the average luminance value MaxFALL, and therefore, the description thereof is omitted here.

Alternatively, the noise reduction apparatus 1a may define a suitable low luminance range for each frame of content based on maximum luminance information (Max Display Mastering Luminance) at the time of creating the content instead of the maximum luminance information d3. The maximum luminance information (Max Display Mastering Luminance) is included in the broadcast stream and denoting the maximum luminance in a monitor (display apparatus) used at the time of creation of the content by a creator of the content. Note that a specific process performed by the luminance coefficient decision unit 123a of this case is similar to the above-described process except that the maximum luminance value MaxCLL in the above-described process is replaced with the maximum luminance information at the time of content creation, and therefore, the description thereof is omitted here.

### Third Embodiment

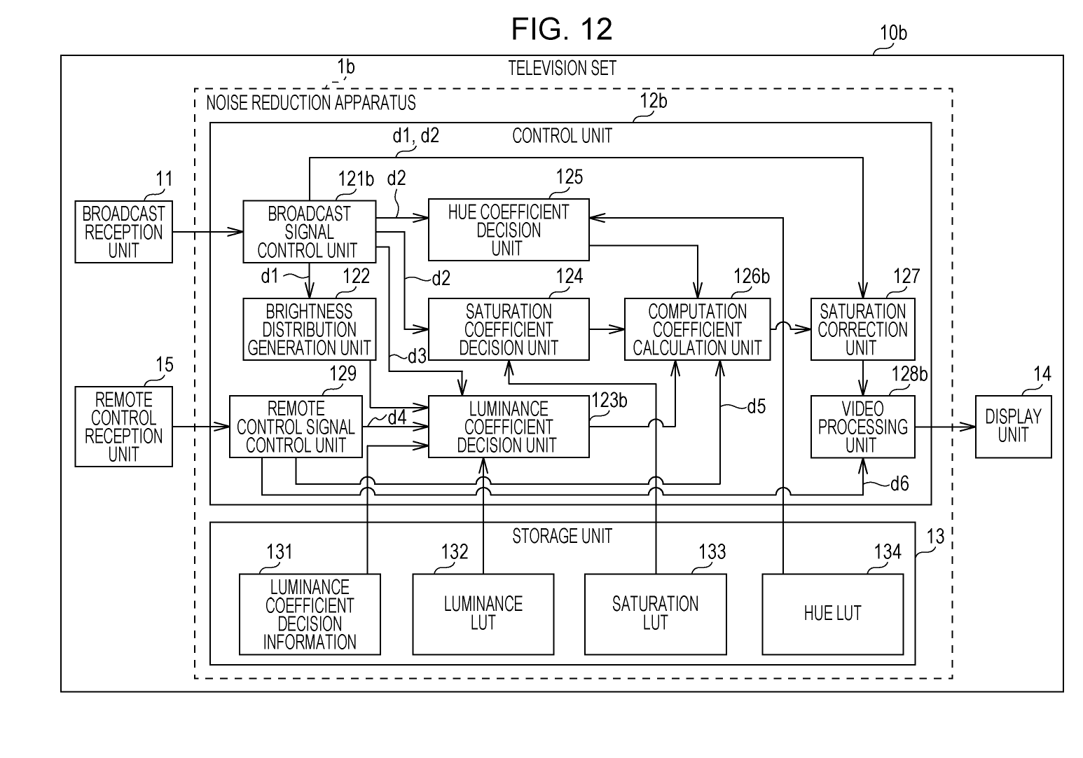

Still another embodiment of the present invention will be described below with reference to FIGS. 12 to 14.

FIG. 12 is a block diagram illustrating an example of main components of a television set 10b according to the present embodiment. The television set 10b (in other words, a noise reduction apparatus 1b with which the television set 10b is equipped) corrects a low luminance range decision coefficient B and/or a computation coefficient A_{T} in accordance with an input signal input by a user (in other words, an operation performed by a user) by using a remote controller (hereinafter referred to as a remote controller 20) or the like of the television set 10b. Details of this will be described below.

As illustrated in FIG. 12, the television set 10b includes a control unit 12b instead of the control unit 12. Moreover, the television set 10b further includes a remote control reception unit 15 configured to receive a signal (hereinafter referred to as a remote control signal) transmitted from the remote controller 20. The control unit 12b includes a broadcast signal control unit 121b, a luminance coefficient decision unit 123b, a computation coefficient calculation unit 126b, and a video processing unit 128b respectively instead of the broadcast signal control unit 121, the luminance coefficient decision unit 123, the computation coefficient calculation unit 126, and the video processing unit 128. Moreover, the control unit 12b further includes a remote control signal control unit 129. Note that the broadcast signal control unit 121b has the same configuration as the broadcast signal control unit 121a described in the second embodiment, and the description thereof is omitted here.

When acquiring the remote control signal from the remote control reception unit 15, the remote control signal control unit 129 specifies an operation instruction included in the remote control signal and outputs the operation instruction to the luminance coefficient decision unit 123b or the computation coefficient calculation unit 126b. Specifically, when the operation instruction, which is specified, is a correction instruction d4 of the low luminance range decision coefficient B, the remote control signal control unit 129 outputs the correction instruction d4 to the luminance coefficient decision unit 123b. When the operation instruction, which is specified, is a correction instruction d5 of the computation coefficient A_{T}, the remote control signal control unit 129 outputs the correction instruction d5 to the computation coefficient calculation unit 126b.

When the operation instruction, which is specified, is a user interface (hereinafter referred to as UI) display instruction d6 which causes a display unit 14 to display a UI for correcting the low luminance range decision coefficient B and/or the computation coefficient A_{T}, the remote control signal control unit 129 outputs the UI display instruction d6 to the video processing unit 128b.

The luminance coefficient decision unit 123b is different from the luminance coefficient decision unit 123 in the following points. That is, the luminance coefficient decision unit 123b corrects the low luminance range decision coefficient B, which is read, based on the correction instruction d4, which is acquired. For example, when the correction instruction d4 is an instruction to multiply the low luminance range decision coefficient by 2, the luminance coefficient decision unit 123b calculates a low luminance range decision coefficient B″ corresponding to the low luminance range decision coefficient B multiplied by 2 in accordance with the instruction and determines a luminance coefficient A_{Y} based on the low luminance range decision coefficient B″.

Note that the luminance coefficient decision unit 123b may be configured, as the luminance coefficient decision unit 123a described in the second embodiment, to correct a low luminance range decision coefficient B′ based on a maximum luminance value MaxCLL and a frame luminance maximum value Yₘₐₓ which are acquired. In this case, the luminance coefficient decision unit 123b further corrects the low luminance range decision coefficient B in accordance with the correction instruction d4, which is acquired.

Note that it is only required that the correction instruction d4 is an instruction to change (correct) the low luminance range, and the value corrected in accordance with the instruction is not limited to the low luminance range decision coefficient B. For example, the luminance coefficient decision unit 123b may correct the maximum luminance value MaxCLL according to the correction instruction d4.

The computation coefficient calculation unit 126b is different from the computation coefficient calculation unit 126 in the following points. That is, the computation coefficient calculation unit 126b corrects the computation coefficient A_{T}, which is calculated, in accordance with the correction instruction d5, which is acquired. For example, when the correction instruction d5 is an instruction to multiply the computation coefficient A_{T} by 0.5, the computation coefficient calculation unit 126b calculates a computation coefficient computation coefficient A_{T} corresponding to the computation coefficient A_{T} multiplied by 0.5 in accordance with the instruction and outputs the computation coefficient. A_{T}′ to a saturation correction unit 127.

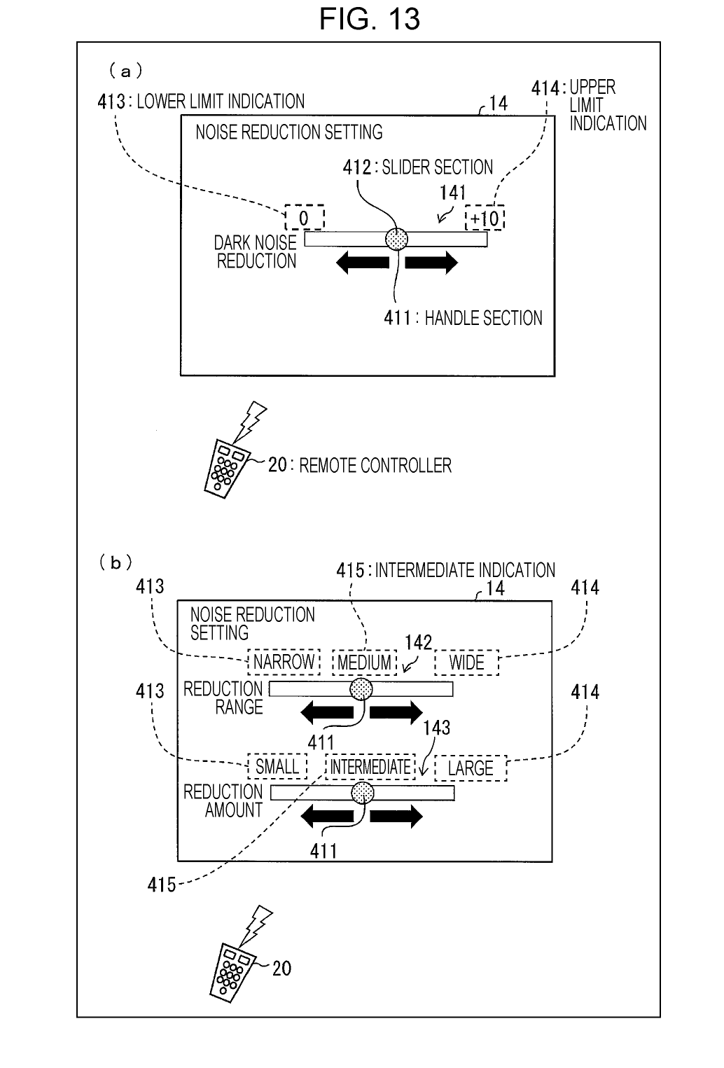

The video processing unit 128b is different from the video processing unit 128 in the following points. That is, when the video processing unit 128b acquires the UI display instruction d6 from the remote control signal control unit 129, the video processing unit 128b causes the display unit 14 to display a UI for correcting the low luminance range decision coefficient B and/or the computation coefficient A_{T}. The UI is not particularly limited this example as long as it can receive the correction of the low luminance range decision coefficient B and/or the computation coefficient A_{T}. The UI may be, for example, a UI illustrated in FIG. 13. FIG. 13 is an example of the UI displayed on the display unit 14.

For example, the video processing unit 128b may, as illustrated in FIG. 13(a), cause a display unit 14 to display a UI 141 for receiving an input for correcting the low luminance range decision coefficient B (or maximum luminance value MaxCLL). Specifically, the UI 141 is a slider whose handle section 411 (a round part of the UI 141) moves on a slider section 412 (a rectangular part of the UI 141) in response to as operation performed on the remote controller 20 by a user. Note that here, description is given of an example in which the handle section 411 of the UI 141 moves, in response to the operation performed on the remote controller 20 by a user, to any one of eleven positions from a position corresponding to a lower limit indication 413 (text denoting “0”) of the slider section 412 (that is, left end of the slider section 412 in FIG. 13(a)) to a position corresponding to an upper limit indication 414 (text denoting “+10”) (that is, right end of the slider section 412 in FIG. 13(a)), but this should not be considered as limiting. In other words, the lower limit indication 413 is an indication denoting a position of the lower limit of the slider section 412, and the upper limit indication 414 is an indication denoting the position of the upper limit of the slider section 412. Moreover, the display unit 14 displays text “dark noise reduction” denoting a process executed by the operation performed on the remote controller 20 by a user when a screen shown in FIG. 13 (a) is displayed.

When the remote control signal control unit 129 acquires a remote control signal denoting that the handle section 411 of the UI 141 has moved from the left end to the right end of the slider section 412 in FIG. 13(a), in other words, to any position between a position corresponding to the lower limit indication 413 (text denoting “0”) to a position corresponding to the upper limit indication 414 (text denoting “+10”) in the slider section 412, the remote control signal control unit 129 outputs, as the correction instruction d4, an instruction to correct the low luminance range decision coefficient B in accordance with the position to the luminance coefficient decision unit 123b. Specifically, the remote control signal control unit 129 reads a LUT (not shown) which is stored in the storage unit 13 and which stores a function of the decree of chance of the low luminance range decision coefficient B with respect to a value denoting the position of the handle section 411 in the slider section 412 (in other words, a value denoting a factor by which the low luminance range decision coefficient B is multiplied). Then, the value denoting the position of the handle section 411 in the slider section 412 is substituted into the function to specify the degree of change of the low luminance range decision coefficient B. The function may be, for example, a linear function according to which when the position of the handle section 411 in the slider section 412 corresponds to a value denoting a position corresponding to the lower limit indication 413 (text denoting “0”) in the slider section 412, the degree of change of the low luminance range decision coefficient B is multiplied by 0, and when the position of the handle section 411 corresponds to a value denoting a position corresponding to the upper limit indication 414 (text denoting “+10”) in the slider section 412, the degree of change of the low luminance range decision coefficient B is multiplied by 2. Note that the function described here is a mere example and is not limited to this example.

Alternatively, for example, the video processing unit 128b may, as illustrated in FIG. 13(b), cause the display unit 14 to display a UI 142 for receiving an input for correcting the low luminance range decision coefficient B (or maximum luminance value MaxCLL) and a UI 143 for receiving an input for correcting the computation coefficient A_{T}. Similarly to the above-described UI 141, description is given of an example in which the UI 142 and the UI 143 are sliders whose handle section 411 moves, in response to an operation performed on the remote controller 20 by a user, to any of eleven positions in the slider section 412, but this should not be considered as limiting.

Note that the UI 142 includes text denoting “narrow” as the lower limit indication 413 and includes text denoting “wide” as the upper limit indication 414. Moreover, the UI 142 further includes an intermediate display 415 (text denoting “medium”) denoting a position corresponding to the center of the slider section 412. On the other hand, the UI 143 includes text denoting “small” as the lower limit indication 413 and includes text denoting “large” as the upper limit indication 414. Moreover, similarly to the UI 142, the UI 143 includes text “intermediate” as the intermediate display 415. Moreover, the display unit 14 displays, adjacently to the UI 142 and the UI 143 respectively, text “reduction range” and “reduction amount” denoting a process executed by an operation performed on the remote controller 20 by a user when a screen shown in FIG. 13(b) is displayed.

When the remote control signal control unit 129 acquires a remote control signal denoting that the handle section 411 of the UI 142 has moved from the left end to the right end of the slider section 412 in FIG. 13(b), in other words, to any position between a position corresponding to the lower limit indication 413 (text denoting “narrow”) to a position corresponding to the upper limit indication 414 (text denoting “wide”) in the slider section 412, the remote control signal control unit 129 outputs, to the luminance coefficient decision unit 123b, an instruction to correct the low luminance range decision coefficient B in accordance with the position as the correction instruction d4. This process is similar to the process performed when the remote control signal denoting that the handle section 411 of the above-described UI 141 has moved on the slider section 412 is received, and the description thereof is thus omitted here.

When the remote control signal control unit 129 acquires a remote control signal denoting that the handle section 411 of the UI 143 has moved from the left end to the right end of the slider section 412 in FIG. 13(b), in other words, to any position between a position corresponding to the lower limit indication 413 (text denoting “small”) to a position corresponding to the upper limit indication 414 (text denoting “large”) in the slider section 412, the remote control signal control unit 129 outputs, to a computation coefficient calculation unit 126, an instruction to correct the computation coefficient A_{T} in accordance with the position as the correction instruction d5. Specifically, the remote control signal control unit 129 reads a LUT (not shown) which is stored in the storage unit 13 and which stores a function of the degree of change of the computation coefficient A_{T} with respect to a value denoting the position of the handle section 411 in the slider section 412 (in other words, a value denoting a factor by which the computation coefficient A_{T} is multiplied). Then, the value denoting the position of the handle section 411 in the slider section 412 is substituted into the function to specify the degree of change of the computation coefficient A_{T}. The function may be, for example, a linear function according to which when the position of the handle section 411 in the slider section 412 corresponds to a value denoting a position corresponding to the lower limit indication 413 (text denoting “small”) in the slider section 412, the degree of change of the computation coefficient A_{T} is multiplied by 1, and when the position of the handle section 411 corresponds to a value denoting a position corresponding to the upper limit indication 414 (text denoting “large”) in the slider section 412, the degree of change of the computation coefficient A_{T} is multiplied by 0.1. Note that the function described here is a mere example and is not limited to this example.

Note that the remote control signal control unit 129 may be configured to output the remote control signal acquired from the remote control reception unit 15 as is to the luminance coefficient decision unit 123b, the computation coefficient calculation unit 126b, or the video processing unit 128b. In the case of this example, the remote control signal control unit 129 determines an output destination to which the remote control signal, which is acquired, is to be output, and the remote control signal control unit 129 outputs the remote control signal to the output destination, which is determined. Moreover, the luminance coefficient decision unit 123b and the computation coefficient calculation unit 126b correct the low luminance range decision coefficient B or the computation coefficient A_{T} in accordance with the remote control signal. Moreover, the video processing unit 128b causes the display unit 14 to display a UI according to the remote control signal.

Moreover, in the present embodiment, the remote controller 20 and the remote control reception unit 15 have been described as examples of components for receiving an input operation performed by a user, but the components for receiving the input operation given by the user are not limited to these examples. For example, the component may be a physical button provided to the television set 10b or a touch screen superimposed on the display unit 14. Alternatively, the remote controller 20 may include only the physical button as illustrated in FIG. 13 or may include a touch screen in addition to, or alternatively to, the physical button.

### (Variation of Third Embodiment)

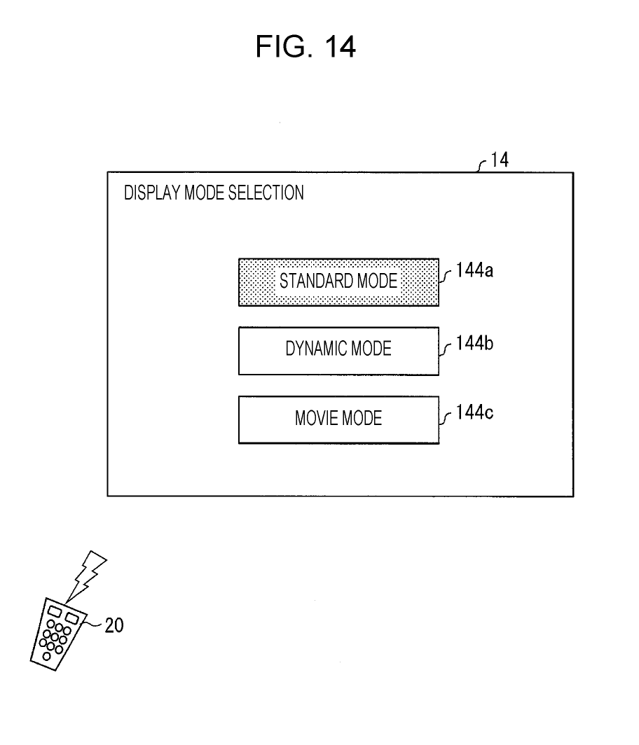

The television set 10b according to the present embodiment may enable a user to select a display mode of a content and may correct the low luminance range decision coefficient B or the maximum luminance value MaxCLL in accordance with the display mode selected by the user. In the case of this example, the video processing unit 128b may cause the display unit 14 to display a UI which enables a user to select the display mode of the content. The UI is not particularly limited to this example as long as it enables a user to select the display mode of the content, but the UI may be, for example, the UI illustrated in FIG. 14. FIG. 14 is a view illustrating another example of a UI displayed on the display unit 14. Note that the present variation describes an example in which the maximum luminance value MaxCLL is corrected.

A UI 144a, a UI 144b, and a UI 144c shown in FIG. 14 are UIs for receiving a change of the display mode of the content. Note that when the UI 144a, the UI 144b, and the UI 144c do not have to be distinguished from one another, they are referred to as UIs 144. Moreover, the display unit 14 displays text “display mode selection” denoting a process executed by an operation performed on the remote controller 20 by a user when a screen shown in FIG. 14 is displayed.

A user operates the remote controller 20 as illustrated in the figure to select a desired display mode from “standard mode”, “dynamic mode”, and “movie mode”. Here, these modes are briefly described. The “dynamic mode” is a mode for performing a video process for vividly displaying the content (specifically, for increasing the saturation of each pixel) and a mode suitable for a case where the content corresponds to video of sports broadcast or live video of music. The “movie mode” is a mode for performing a video process so that the content is displayed with reduced. vividness (specifically, so that the saturation of each pixel is reduced) and suitable for a case where the content corresponds to movies or the like. The “standard mode” is a mode in which a video process according to the content is not performed in the television set 10b. Note that the display modes of the contents described here are mere examples, and the display mode of the contents is not limited to these examples.

When the remote control signal control unit 129 acquires a remote control signal denoting a display mode which is selected, the remote control signal control unit 129 changes the degree of change of the maximum luminance value MaxCLL (in other words, a value denoting a factor by which the maximum luminance value MaxCLL is multiplied) according to the remote control signal, which is acquired. Specifically, when receiving a remote control signal denoting that the “standard mode” is selected, the remote control signal control unit 129 outputs, to the luminance coefficient decision unit 123b, the correction instruction d4 that the degree of change of the maximum luminance value MaxCLL is multiplied by 1. Note that when the “standard mode” is selected, the maximum luminance value MaxCLL does not change, and therefore, the remote control signal control unit 129 may be configured not to output the correction instruction d4.

Alternatively, when acquiring a remote control signal denoting that the “dynamic mode” is selected, the remote control signal control unit 129 outputs, to the luminance coefficient decision unit 123b, the correction instruction d4 that the decree of chance of the maximum luminance value MaxCLL is multiplied by 1.5. This is because the dynamic mode is a mode for performing a video process for increasing the saturation of each pixel, and therefore, color noise is highly possibly emphasized. That is, since the maximum luminance value MaxCLL is multiplied by 1.5 as described above to increase the low luminance range (that is, a range in which correction of reducing the saturation is performed), selecting the “dynamic mode” enables color noise to be reduced in a pixel in which the occurrence of the color noise is concerned (in other words, a pixel newly included in the low luminance range due to the correction made to the maximum luminance value MaxCLL).

Alternatively, when acquiring a remote control signal denoting that the “movie mode” is selected, the remote control signal control unit 129 outputs, to the luminance coefficient decision unit 123b, the correction instruction d4 that the degree of change of the maximum luminance value MaxCLL is multiplied by 0.5. This is because the movie mode is a mode for performing a video process for reducing the saturation of each pixel, and therefore, if the low luminance range is not corrected, the saturation of a pixel which does not have to be subjected to noise reduction may also be reduced. That is, since the maximum luminance value MaxCLL is multiplied by 0.5 as described above to reduce the low luminance range (that is, a range in which correction of reducing the saturation is performed), excessive correction of contents can be prevented. Note that the degree of change of the maximum luminance value MaxCLL described here is a mere example and is not limited to this example.

### (Other Variation)

The luminance coefficient decision unit 123, the luminance coefficient decision unit 123a, and the luminance coefficient decision unit 123b (when these are not necessary to be distinguished from one another, they are hereinafter referred to as luminance coefficient decision units 123) according to the above-described embodiments may correct the low luminance range decision coefficient B or the maximum luminance value MaxCLL in accordance with a content. Specifically, the luminance coefficient decision unit 123 acquires information (movie, sports broadcast, drama, etc.) denoting the kinds of a content from the broadcast signal control unit 121 and corrects the low luminance range decision coefficient B or the maximum luminance value MaxCLL in accordance with the information. For example, when the information is information denoting that the content is movie, the maximum luminance value MaxCLL is multiplied by 0.5. Alternatively, for example, when the information is information denoting that the content is sports broadcast, the maximum luminance value MaxCLL is multiplied by 1.5. Note that the luminance coefficient decision unit 123 may acquire the information denoting the kinds of the content from Electronic Program Guide (EPG).

Moreover, the computation coefficient calculation unit 126 and the computation coefficient calculation unit 126b according to the above-described embodiments (when they are not necessary to be distinguished from each other, they are hereinafter referred to as computation coefficient calculation units 126) calculate the computation coefficient A_{T} based on the luminance coefficient A_{Y}, the saturation coefficient A_{S}, and the hue coefficient A_{H}, but this should not be construed as limiting. Specifically, it is only required that the computation coefficient calculation units 126 determine the computation coefficient. A_{T} based on at least the luminance coefficient A_{Y}. Note that when only the luminance coefficient. A_{Y} is used, the computation coefficient calculation unit 126 outputs as the computation coefficient A_{T}, the luminance coefficient A_{Y}, which is acquired, to the saturation correction unit 127.

### [Realization Example by Software]

A control block (in particular, each component included in the control units 12, 12a, 12b) of the noise reduction apparatus 1, 1a, 1b may be realized by a logic circuit (hardware) formed in, for example, an integrated circuit (IC chip) or by software by using a Central Processing Unit (CPU).

In the latter case, the noise reduction apparatus 1, 1a, 1b includes, for example, a CPU configured to execute a command of a program serving as software which realizes various functions, Read Only Memory (ROM) or storage device (which is referred to as a “storage medium”) in which the program and various types of data are stored in a computer (or CPU)-readable manner, and Random Access Memory (RAM) into which the program is to be loaded. The computer (or the CPU) reads the program from the storage medium and executes the program to achieve the object of the present invention. As the storage medium, a “non-transitory tangible medium”, for example, a tape, disk, card, semiconductor memory, or programmable logic circuit may be used. Moreover, the program may be provided to the computer via any transmission medium (for example, a communication network or a broadcast wave) which can transmit the program. Note that the present invention can be realized in a form of a data signal which is realized by electronical transmission of the program and which is embedded in a carrier wave.

### SUMMARY

A display control device (noise reduction apparatus 1) according to a first aspect of the present invention includes a saturation changing unit (saturation correction unit 127) configured to reduce saturation of a pixel having luminance lower than luminance corresponding to a first value according to luminance of an image to be displayed while the luminance of the pixel is maintained.

This configuration reduces the saturation of a pixel whose luminance is lower than the first value. In other words, this configuration does not reduce the saturation of a pixel whose luminance is higher than or equal to the first value. Thus, the saturation in only a low luminance region of an image can be reduced. When the saturation of the pixel in the low luminance region is reduced, a difference between the color of the pixel and a color of a neighbor pixel becomes unnoticeable. Thus, color noise generated in the low luminance region in an image becomes unnoticeable

Thus, the color noise generated in the low luminance region in the image can be made unnoticeable. Consequently, color noise can be reduced. Moreover, with this configuration, the luminance of the pixel whose saturation is reduced is maintained, and therefore, color noise can be reduced without reducing the information amount of the image.

A display control apparatus according to a second aspect of the present invention referring to the first aspect further includes a maximum value specification unit (brightness distribution generation unit 122) configured, to specify a maximum value of the luminance of the image, wherein the first value may be a value that amounts to a prescribed ratio with respect to the maximum value.

With this configuration, the first value is the value that amounts to the prescribed ratio with respect to the maximum value of the luminance of the image. Thus, the value can be changed in accordance with the maximum value of the luminance of the image, and therefore, it is possible to configure an appropriate low luminance region in each image. Thus, it is possible to reduce color noise in only appropriate pixels in each image.

In a display control apparatus according to a third aspect of the present invention referring to the second aspect, the prescribed ratio may re small when the difference between the maximum value of the luminance of the image and a maximum value of luminance of a content including the image is large, the maximum value of the luminance of the content being pre-configured in the content, and the prescribed ratio may be large when the difference between the maximum value of the luminance of the image and the maximum value of the luminance of the content is small.

With this configuration, the prescribed ratio is small when a difference between the maximum value of the luminance of the image and a maximum value of luminance of a content is large, and the prescribed ratio is large when the difference between the maximum value of the luminance of the image and the maximum value of the luminance of the content is small. Thus, depending on whether an image as a target from which noise is to be reduced is an image of a dark scene in the content or an image of a bright scene in the content, a pixel which is a target from which noise is to be reduced (in other words saturation reduction target) can be changed. Thus, appropriate noise reduction can be performed in the image.

In a display control apparatus according to a fourth aspect of the present invention referring to the second or third aspect, the prescribed ratio may be changed in accordance with an. operation performed by a user.

With this configuration, the prescribed ratio is changed in accordance with the operation performed by a user. Therefore, a pixel as a target from which noise is to be reduced (in other words saturation reduction target) can be changed in accordance with the operation performed by a user. Thus, a pixel as a target from which noise is to be reduced can be desirable for a user.

In a display control apparatus according to a fifth aspect of the present invention referring to the fourth aspect, a user interface for changing the prescribed ratio may be displayed on a display apparatus.

With this configuration, a user interface for changing the prescribed ratio is displayed on the display apparatus. Therefore, a user can check the modification of the prescribed ratio. Thus, it is possible to realize a display control device easily usable by a user.

In a display control apparatus according to a sixth aspect of the present invention referring to any one of the first to fifth aspects, the saturation changing unit may reduce saturation of a pixel to 0, the pixel having luminance included within a range of 0 to a second value, the second value being a value according to the luminance of the image and being a smaller value than the first value, and the saturation changing unit may reduce the extent of reduction of saturation of a pixel having luminance included within a range of the second value to the first value as the luminance increases.

With this configuration, the saturation of the pixel having luminance included within a range of 0 to the second value is reduced to 0, and thus, color noise in a further low luminance region (in other words, a region in which color noise is more noticeable) of the low luminance region can accordingly be reduced. Moreover, the extent of reduction of saturation of pixel having luminance included within a range of the second value to the first value is reduced as the luminance increases. Therefore, between pixels with small luminance differences, in particular between pixels whose luminance corresponds to a value around the second value, a precipitous change of saturation can be reduced.

In a display control apparatus according to a seventh aspect of the present invention referring to any one of the first to sixth aspects, the saturation changing unit may increase an extent of reduction of saturation for a pixel whose hue is closer to blue.

The color noise is noise which is more noticeable with hue closer to blue. Here, with this configuration, the extent of reduction of saturation is increased for a pixel whose hue is closer to blue. Thus, color noise which is more noticeable can be made more unnoticeable, and thus, it is possible to realize a more effective color noise reduction.

In a display control apparatus according to an eighth aspect of the present invention referring to any one of the first to seventh aspects, the saturation changing unit may increase an extent of reduction of saturation for a pixel having higher saturation.

With this configuration, the extent of reduction of saturation is increased for a pixel having higher saturation, and therefore, the saturation of the pixel which is closer to the original color (in other words, color noise is more noticeable) can be more reduced. Thus, it is possible to realize a more effective color noise reduction.

A display apparatus (television set 10) according to a ninth aspect of the present invention may include the display control device according to any one of the first to eighth aspects.

With this configuration, it is possible to realize a display apparatus which enables color noise in a low luminance region of an image to be reduced without reducing the information amount of the image.

A television receiver (television set 10) according to a tenth aspect of the present invention may include the display control device according to any one of the first to eighth aspects.

With this configuration, it is possible to realize a television receiver which enables color noise in a low luminance region of an image to be reduced without reducing the information amount of the image.

A control method of a display control device according to an eleventh aspect of the present invention includes a saturation changing step (step S8) of reducing saturation of a pixel having luminance lower than luminance corresponding to a first value according to luminance of an image to be displayed while the luminance of the pixel is maintained.

This configuration provides an effect similar to that provided by the display control device according to the first aspect.

The display control device according to each aspect of the present invention may be realized by a computer. In this case, the scope of the present invention includes a control program of the display control device which causes a computer to operate as each component (software element) included in the display control device to realize the display control device by the computer, and a computer-readable recording medium which stores the control program.

The present invention is not limited to the embodiments described above. Various modifications may be made within the scope of the claims. Embodiments obtained by accordingly combining the techniques disclosed in different embodiments are also within the technical scope of the present invention. Moreover, combining technical means disclosed in the embodiments can provide new technical feature.

### REFERENCE SIGNS LIST

1 NOISE REDUCTION APPARATUS (DISPLAY CONTROL DEVICE)

10 TELEVISION SET (DISPLAY APPARATUS, TELEVISION RECEIVER)

122 BRIGHTNESS DISTRIBUTION GENERATION UNIT (MAXIMUM VALUE SPECIFICATION UNIT)

127 SATURATION CORRECTION UNIT (SATURATION CHANGING UNIT)

S8 SATURATION CHANGING STEP

1. A display control device comprising:
a saturation changing unit configured to reduce saturation of a pixel having luminance lower than luminance corresponding to a first value according to luminance of an image to be displayed while the luminance of the pixel is maintained.

2. The display control device according to claim 1, further comprising:
a maximum value specification unit configured to specify a maximum value of the luminance of the image, wherein
the first value is a value that amounts to a prescribed ratio with respect to the maximum value.

3. The display control device according to claim 2, wherein
the prescribed ratio is small when a difference between the maximum value of the luminance of the image and a maximum value of luminance of a content including the image is large, the maximum value of the luminance of the content being pre-configured in the content, and
the prescribed ratio is large when the difference between the maximum value of the luminance of the image and the maximum value of the luminance of the content is small.

4. The display control device according to claim 2, wherein
the prescribed ratio is changed in accordance with an operation performed by a user.

5. The display control device according to claim 4, wherein
a user interface for changing the prescribed ratio is displayed on a display apparatus.

6. The display control device according to claim 1, wherein
the saturation changing unit reduces saturation of a pixel to 0, the pixel having luminance included within a range of 0 to a second value, the second value being a value according to the luminance of the image and being a smaller value than the first value, and
the saturation changing unit reduces an extent of reduction of saturation of a pixel having luminance included within a range of the second value to the first value as the luminance increases.

7. The display control device according to claim 1, wherein
the saturation changing unit increases an extent of reduction of saturation for a pixel whose hue is closer to blue.

8. The display control device according to claim 1, wherein
the saturation changing unit increases an extent of reduction of saturation for a pixel having higher saturation.

9. A display apparatus comprising:
the display control device according to claim 1.

10. A television receiver comprising:
the display control device according to claim 1.

11. A control method for a display control device, the control method comprising:
a saturation changing step of reducing saturation of a pixel having luminance lower than luminance corresponding to a first value according to luminance of an image to be displayed while the luminance of the pixel is maintained.

12. (canceled)

13. A computer-readable non-transitory recording medium on which a control program for causing a computer to function as the display control device according to claim 1 is stored, the computer being caused to function as the saturation changing unit.
